(19) United States
(12) Patent Application Publication
(10) Pub. No.: US 2005/0223145 A1
(43) Pub. Date: Oct. 6, 2005

(54) System, apparatus and method for migrating computer environment and associated computer readable recording medium

(76) Inventors: Jin-min Lin, Taipei City (TW); Chih-ling Wang, Taipei City (TW); Yao-Shun Hung, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/097,328

(22) Filed: Apr. 4, 2005

(30) Foreign Application Priority Data
Apr. 5, 2004 (TW) 93109375

(51) Int. Cl. G06F 13/12

(52) U.S. Cl. 710/62

(57) ABSTRACT

A system, related apparatus, method and a computer accessible storage medium for operation environment migration are provided. The system includes a first PC, a second PC, and a USB migration cable having a first USB connector and a second USB connector. The USB migration cable includes a first USB connector, a second USB connector, a first USB controller coupled to the first USB connector, having an embedded first flash memory storing a non-volatile first firmware for operating the first USB controller, and a second USB controller coupled to the first USB controller, having an embedded second flash memory storing a non-volatile second firmware for operating the second USB controller, where the USB migration device uses the first USB controller to couple a first PC and the second USB controller to couple a second PC so that the second PC can automatically execute the drivers and the applications installed in the first PC to operate the USB migration device according to the autorun image file. The first PC can obtain the operation environment of the second PC through the USB migration device. Preferably, the operation environment includes the application installed, address book of the e-mail program, and the favorite list of the internet browser.

### BACKGROUND OF THE INVENTION

1. Field of the Invention

The present invention generally relates to a system, related apparatus and method for migrating computer environment and associated computer readable recording medium and, more particularly to a system, related apparatus and method for migrating computer environment between two computers and associated computer readable recording medium.

2. The Related Art

The conventional PC takes a long time to update to a new operation system and reinstall all the existing application programs, such as various setting and copying the address books in the e-mail application to the new environment. The users who are not familiar with the operation may even try to re-key in all the e-mail addresses. Without the familiar setting and application programs installed, the user might have difficulty to use a new operation system or a new computer. Therefore, re-installation of the operation system or updating to a new operation system is usually a painful and time-consuming experience for most users.

The universal serial bus (USB) controller has evolved from USB1.1 to USB2.0, and the transmission bandwidth has increased from 12 Mbps to 480M bps. USB prevails in various applications such as memory sticks, card reader, mouse, keyboard, and so on. USB is popular for plug-and-play so as to become a standard interface of PC.

### SUMMARY OF THE INVENTION

The present invention discloses a method for operation environment migration, including the following steps: determining if the vendor ID and product ID of a USB device is recognizable, declaring the first function of the USB device is a compact disk ROM, declaring the second function of the USB device is a USB migration device, automatically installing and executing the drivers and applications at the remote PC to the local PC based on the first function, analyzing the operation environment at the local PC, and migrating the operation environment at the local PC to the remote PC based on the second function. The operation environment includes a plurality of installed applications, the address book of the e-mail program, the favorite list of the Internet browser and a plurality of e-mails at the local PC.

The present invention also discloses a method for operation environment migration, including the following steps: the first PC inquires regularly to the USB migration device if a second PC is connected, automatically installing and executing the programs installed at the first PC to the second PC, such as applications and drivers, and sending the computing environment at the first PC to the second PC or the first PC obtaining the computing environment of the second PC.

The present invention further discloses a USB migration device, including a first USB connector, a second USB connector, a first USB controller coupled to the first USB connector, having an embedded first flash memory storing a non-volatile first firmware for operating the first USB controller, and a second USB controller coupled to the first USB controller, having an embedded second flash memory storing a non-volatile second firmware for operating the second USB controller, where the USB migration device uses the first USB controller to couple a first PC and the second USB controller to couple a second PC so that the second PC can automatically execute the drivers and the applications installed in the first PC to operate the USB migration device according to the autorun image file. Preferably, the first firmware and the second firmware are identical. When the applications are successfully installed at the second PC, the applications can analyze the operation environment at the second PC. During the initialization stage of the USB migration device, the USB migration device can report that the second PC is a USB compact disk ROM with a large storage. Preferably, the embedded second flash memory has a table of content (TOC) information, including the type and the starting address of the first track of the compact disk, so that the USB migration device can directly report the TOC information in the second flash memory to the second PC.

The present invention also discloses a system for operation environment migration, including a first PC, a second PC, and a USB migration cable having a first USB connector and a second USB connector. The USB migration cable includes a first USB connector, a second USB connector, a first USB controller coupled to the first USB connector, having an embedded first flash memory storing a non-volatile first firmware for operating the first USB controller, and a second USB controller coupled to the first USB controller, having an embedded second flash memory storing a non-volatile second firmware for operating the second USB controller, where the USB migration device uses the first USB controller to couple a first PC and the second USB controller to couple a second PC so that the second PC can automatically execute the drivers and the applications installed in the first PC to operate the USB migration device according to the autorun image file. The first PC can obtain the operation environment of the second PC through the USB migration device. Preferably, the operation environment includes the application installed, address book of the e-mail program, and the favorite list of the Internet browser.

The present invention further discloses a storage media for computer access. The storage media stores a computer executable program. The storage media include a inquiry device which inquires, at a regular interval, the USB migration cable if a remote PC is connected, a transmission device for transmitting data through the USB migration cable to the remote PC for its installation of drivers and applications when the remote PC is confirmed by the inquiry device to be connected to the USB migration cable, a migration device for either obtaining an operation environment from a remote PC or sending an operation environment to the remote PC, and a detection device for detecting the version of the operation system at the remote PC. The applications can analyze the operation environment of the remote PC and obtain the operation environment through the USB migration cable.

The present invention further discloses a method for operation environment migration, including: determining if the vendor ID and product ID of the USB device are recognizable, declaring the USB device having the function of a compact disk ROM, based on the function, automatically installing and executing the drivers and the applications stored at the remote PC to the local PC, analyzing the operation environment of the local PC, and using the specific SCSI command to migrate the operation environment at the local PC to the remote PC.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

FIG. 1 shows a USB migration cable according to an embodiment of the present invention.

FIG. 2 shows a flowchart of an operation environment migration method according to the present invention.

FIG. 3 shows another flowchart of the operation environment migration method according to the present invention.

FIG. 4 shows the operation flow of the main program of a migration cable according to the present invention.

### DETAILED DESCRIPTION OF THE PREFERRED EMBODIMENTS

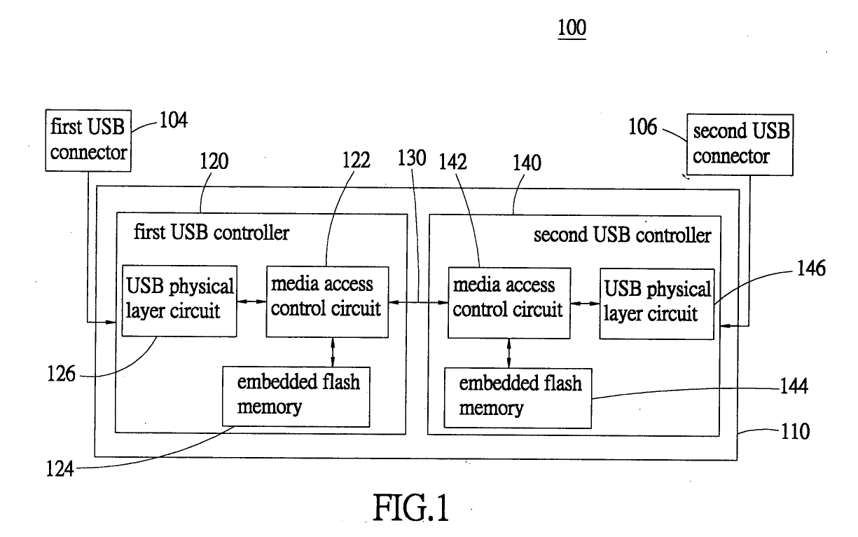

With reference to the drawings and in particular to FIG. 1, which shows a USB migration cable according to an embodiment of the present invention, a USB migration cable 100 connects two PCs (not shown), including a USB migration device 110, a USB connection cable 102, a first USB connector 104, and a second USB connector 106. Preferably, first USB connector 104 and second USB connector 106 are both USB A-type plug connectors for connecting the USB A-type receptacle connector on the PCs. USB migration device 110 includes a first USB controller 120 coupling through a bus 130 to second USB controller 140. Preferably, first USB controller 120 and second USB controller 140 are structurally identical in hardware. First USB controller 120 includes a media access control circuit 122, an embedded flash memory 124, and a USB physical layer circuit 126. Second USB controller 140 includes a media access control circuit 142, an embedded flash memory 144, and a USB physical layer circuit 146. Embedded flash memories 124, 144 are preferably manufactured into the first and second USB controllers 120, 140 together with media access control circuits 122, 142 and physical layer circuits 126, 146 during the manufacturing process of foundry. The capacity of embedded flash memories 124, 144 is smaller, for example, 32K bytes, and the size of the die will increase slightly, while the manufacturing cost will is acceptable.

The capacity of embedded flash memories is too small for storing a large amount of data. USB migration cable 100 can migrate the operation environment or part of the operation environment of a second PC (not shown) connected to second USB connector 106 to a first PC (not shown) connected to first USB connector 104, wherein the operation system on the first PC can support the operation of USB migration cable 100. Alternatively, the first PC can pre-install the associated drivers and applications to support the operation of USB migration cable 100. The next generation operation system, such as Longhorn from Microsoft, may directly support the operation of USB migration cable 100 to avoid associated setup and installation.

In this embodiment, the associated operation firmware is non-volatile recorded in first USB controller 120 and second USB controller 140 before USB migration cable is shipped out. The first PC (not shown) is connected to first USB connector 104. At the beginning, first USB controller 120 receives the bus power provided by the PWR and GND lines of the USB receptacle of the PC. First USB controller 120 loads the firmware in embedded flash memory 124 into a RAM (not shown) in media access control circuit 122 so that the RAM cooperates with a processor (such as 8051 processor, not shown) in media access control circuit 122 and the PC issues a reset command and establishes the link. In this embodiment, as previously described, the first PC supports the operation of USB migration cable 100, for example, by installing associated application or next generation operation system. After first USB controller 120 reports the vendor ID (VID) and product ID (PID) to the first PC, USB migration cable starts to operate. The difficulties that need to overcome lie in the operation between second USB controller 140 and the second PC.

During second USB controller 140 establishing connection, it will report its configuration to the second PC. Preferably, the firmware in the embedded flash memory 144 of second USB controller 140 tells the second PC that its logic unit number (LUN) is 1 and the multi-functional USB device has the first function as a CD driver and the second function as the USB migration cable 100. Second USB controller 140 reports to the second PC that it is a CD driver of the mass storage class so that the second PC will treat second USB controller 140 as a CD, although the actual memory space is in the first PC, for example, in hard disk or RAM. Alternatively, by specific file, for example, a binary data file such as an .img or .dat file, the application program can work with that specific file as a CD data file and the access commands can be passed from the firmware in second USB controller 140 to the firmware in first USB controller 120 and finally to the aforementioned application program or operation system in the first PC for interpretation. Preferably, the application program or the operation system in the first PC provides a segment of code for the second PC to execute to operate the application or driver of the corresponding USB migration cable 100, and stores the auto-executable file of the recognizable CD file type seen by the second PC, such as autorun.inf. The autorun.inf can execute the specified code and make the second function of the second PC as a USB migration cable so that it can collaborate with the firmware of USB migration cable 100 stored in embedded flash memory 144 of second USB controller 140.

The description above is for further explaining the operation of the embodiment, including the following issues: if USB migration cable 100 of the present invention is directional, and if the firmware stored respectively in flash memories 124, 144 of first USB controller 120 and second USB controller 140 can be identical so that the manufacturing of USB migration cable 100 can be simplified and the usability increase. The following description further explains the two firmware can be identical so that USB migration cable 100 can be non-directional. Based on the application environment of the embodiment, after first USB connector 104 is connected to the first PC, first USB controller 120 reports the VID and PID of USB migration cable 100 to the first PC, and the LUN is 1 and multi-functions. As the first PC includes an application or operation system that supports USB migration cable, the first PC can recognize the VID and PID to operate USB migration cable 100. Similarly, after second USB connector 106 is connected to second USB controller 140, the same firmware reports the VID and PID of USB migration cable 100 to the second PC, and the LUN is 1 and multi-functions. Because the second PC does not recognize the VID and PID of USB migration cable 100, the second PC will preferably use the multi-functions as described in the earlier embodiment. For the second PC, USB migration cable 100 is treated as a CD player for automatic installation and execution of the driver and application in the first PC so that the second PC can operate USB migration cable normally. Preferably, the application will analyze the operation environment of the second PC, including all the installed application programs, the my-favorite list in the browser, the address book in the e-mail program, and existing e-mail messages. This operation environment will then be migrated to the first PC. Alternatively, the user can selectively migrate a part of the environment to the first PC.

For those skilled in this art, based on the disclosure, can vary the designs that are still within the scope of the present invention. For example, the multi-functions used by second USB controller 140 to enable the second PC install and auto-execute the firmware and application in the first PC can also reports that USB migration cable 100 as single function, such as CD player. After the auto-execution, second USB controller 140 issues a reset command for bus enumeration so that the second PC can recognize the VID and PID to operate USB migration cable 100.

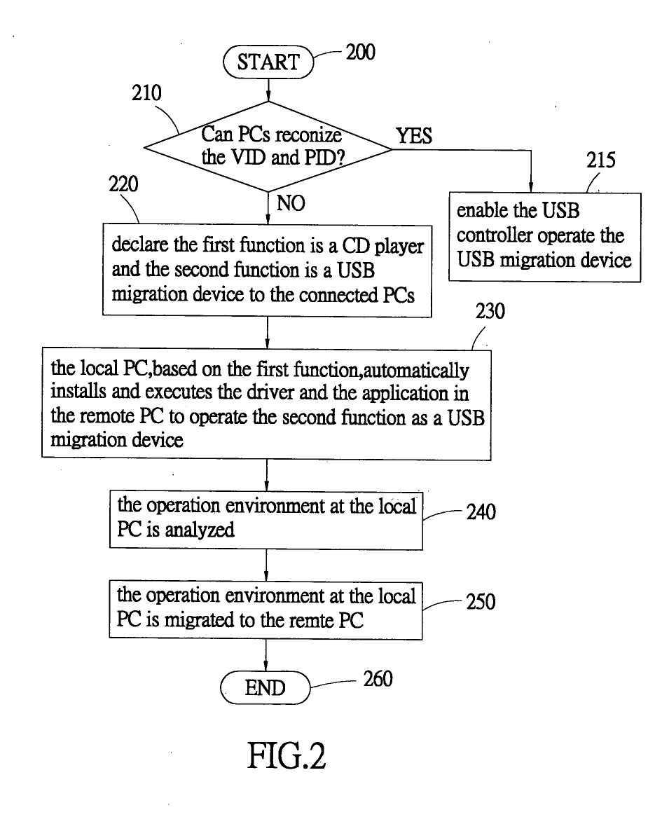

FIG. 2 shows a flowchart of migration method of the embodiment of the present invention. In this flowchart, the operation environment of the local PC is to be migrated to the remote PC. The local PC and the remote PC of the flowchart can be considered as the first PC and the second PC of FIG. 1. That is, the remote PC includes the application or operation system supporting this migration process, and can be used in each USB controller. The process starts with step 200. In step 210, when the USB is provided with DC power, the USB loads the firmware and starts operation. When all the connected PCs recognize the VID and PID, step 215 is taken to enable the USB controller operate the USB migration device; otherwise, step 220 is taken to declare the first function is a CD player and the second function is a USB migration device to the connected PCs. In step 230, the local PC, based on the first function, automatically installs and executes the driver and the application in the remote PC to operate the second function as a USB migration device. For example, the local PC, based on the first function, maps an area in the hard disk or memory on the remote PC as a CD. Alternatively, by specific file, for example, a binary data file such as an .img or .dat file, the application program can work with that specific file as a CD data file. Preferably, the CD stores the auto-executable file, such as autorun.inf, for automatic installation and execution of a specific code so that the local PC can operate the USB controller as a USB migration device. In step 240, the operation environment at the local PC is analyzed, for example, the installed application programs, the my-favorite list of the web browser, address book, and so on. In step 250, based on the USB migration device and the analysis result, the operation environment at the local PC is migrated to the remote PC, and step 260 terminates the process.

The first and the second functions in FIG. 2 will be further explained. The USB hardware must include a plurality of endpoints to declare multi-functions. For example, the media access controllers in FIG. 1 all have a ping-pong buffer to speed up the data buffering. The ping-pong buffer includes a pair of 512-byte buffers. When the first 512-byte buffer is full and forwards the data to the next stage, the other buffer starts to receive data at the same time to accelerate the data buffering. To declare the multi-functions to include the first and the second functions, the hardware must include two ping-pong buffers, that is, two endpoints, to correspond to the two functions.

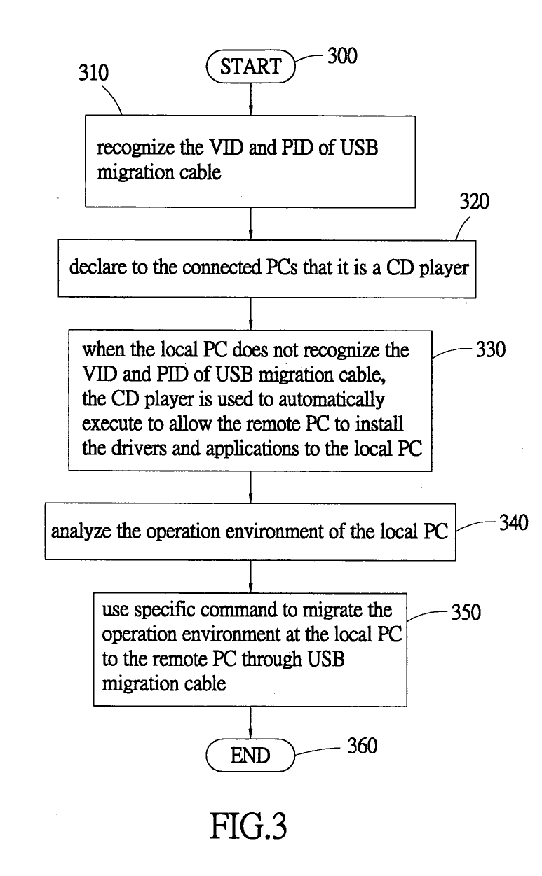

FIG. 3 shows the flowchart of another embodiment of the present invention. In this flowchart, the operation environment of a local PC is to migrate to a remote PC. Preferably, a single USB function is used in this embodiment. Refer to USB migration cable 100 in FIG. 1. USB migration cable 100 is preferably symmetric; that is, the hardware structure and the firmware in both first USB controller 120 and second USB controller 140 are identical. It is worth noticing that those skilled in this art can easily conclude that a directional USB migration cable 100, with an external switch to determine the direction of the cable, and so on, are still within the scope of the present invention. The process starts with step 300. It is worth noticing that before the operation of USB migration cable 100, at least one of the two connected PCs must be installed with related drivers and applications, which may also be supplemented by the operation system as built-in programs. Step 310 is to try recognizing the VID and PID of USB migration cable 100. Step 320 is to declare to the connected PCs that it is a CD player. In step 330, when the local PC does not recognize the VID and PID of USB migration cable 100, the CD player declared in step 320 is used to automatically execute to allow the remote PC to install the drivers and applications to the local PC. For example, in step 320, the local PC will see the remote PC as a CD player. The USB device of the type of CD player supports automatic execution, such as autorun.inf. Therefore, the local PC will follow the description provided by the autorun.inf in the CD player mapped by the remote PC to install driver and application so that the local PC can also support the following operation of USB migration cable 100. On the other hand, the remote PC recognizes the VID and PID of USB migration cable 100 from the beginning. Therefore, although USB migration cable 100 is declared to be a CD player to the remote PC, the remote PC can still overwrite the automatic installation by autorun image file, or allows the new version of autorun image file to correctly replace the older version. On the other hand, if both PCs are supported by next generation operation system, both can determine the operation direction of USB migration cable 100 based on the time of operation system installation. In general, the default can be set as migrating the operation environment to the newer operation environment. Step 340 is to analyze the operation environment of the local PC. For example, the operation environment includes, but not limited to, installed application programs, my-favorite in the web browser, address book of e-mail program, existing e-mail messages, and so on. Step 350 is to use specific command, such as specially designed SCSI command, to migrate the operation environment at the local PC to the remote PC through USB migration cable 100. Alternatively, the user can selectively decide which part of the operation environment to be migrated through USB migration cable 100. The process terminates with step 360.

The embodiment in FIG. 3 shows that a single function and special command can also realize the present invention. Therefore, the hardware complexity and the manufacture cost can both be reduced. As shown in FIG. 1, the media access controller only needs a pair of 512-byte buffers to realize the ping-pong buffer to implement this single function, instead of the multi-functions in FIG. 2, which requires different hardware for different function. For example, the remote PC can recognize USB migration cable 100 by its VID and PID at the beginning. The remote PC performs periodic polling to USB migration cable 100. Before the local PC is ready, USB migration cable 100 responds with a “Not Ready” signal. The remote PC will learn about the status when the local PC uses ATAPI to issue CD access commands. The remote PC uses its application and specified binary file to simulate a CD player to replies the data to the local PC.

The following shows an embodiment of a pseudo code, which, preferably, is included in the next generation operation system, such as Microsoft Longhorn Windows:

main( )
{
//when USB migration cable plugged to USB port of PC with Longhorn O.S.

| | |
|---|---|
| while(Connection( ) == 0) { | // check if the other PC is connected |
| sleep(1000) ; | // delay for a second |
| } | // until the other PC is connected to cable |
| SendAutorunImage( ); | // send autorun image to the other end |
| if(DoorClose( )){ | // if the other end is also Longhorn |
| if(SourceSystem( )){ | // confirm if it is the source end |
| SendMigrationData( ); | // migrate operation environment to the other end |
| } else GetMigrationData( ); | // receive operation environment |
| } else | // the other end is XP/2000/ME |
| GetMigrationData( ); | // receive operation environment from the other end |
| } | |
| int Connection(void) | |
| { | |
| SCSI_Connection( ) | // Issue a SCSI command via USB storage class. |

```
  // Return 0 if the other side is not connected or does not issue read autorun image command.
  // Return 1 if the other side is connected and issue read autorun image command.
}
void SendAutorunImage(void)
{
```

| | |
|---|---|
| SCSI_BulkOutAutorunImage( ) | // Issue a SCSI command via USB storage class. |

```
  // Send autorun image to the other side via bulk out pipe.
  // Some autorun information may be stored in firmware code flash.
}
void SendMigrationData(void)
{
```

| | |
|---|---|
| SCSI_BulkOutMigrationData( ) | // Issue a SCSI command via USB storage class |
| | // Send migration data to the other side |
| | via bulk out pipe |
| } | |
| void GetMigrationData(void) | |
| { | |
| SCSI_BulkInMigrationData( ) | // Issue a SCSI command via USB storage class |
| | // Get migration data from the other side via bulk in pipe |
| } | |
| int DoorClose(void) | |
| { | |
| SCSI_DoorClose( ) | // Issue a SCSI command via USB storage to |
| | detect CD-ROM |
| | // Return 0 if CD-ROM door opens (CD medium is not OK) |
| | // Return 1 if CD-ROM door close (CD medium is OK) |
| } | |

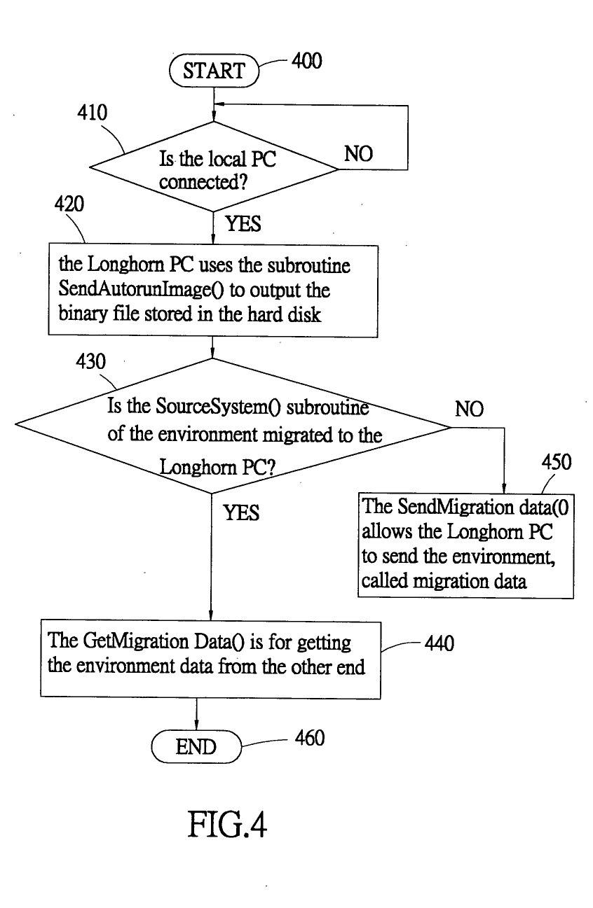

The above pseudo code is based on the flowchart of FIG. 3. To migrate the operation environment at the local PC to the remote PC and the focus of discussion is on the remote PC, the flowchart of USB migration cable 100 is as shown in FIG. 4. Starting with step 400, the process assumes that the remote PC is equipped with Longhorn operation system, referred hereby as called Longhorn PC. The Longhorn operation system preferably includes the above pseudo code. The local PC installs, preferably, an XP/2000/ME operation system. As shown in step 310, the Longhorn PC recognizes the VID and PID of the present invention, and performs bus enumeration to wake up the main program main( ), which periodically, at an interval of 1 second, uses the subroutine Connection( ) to issue a special SCI command through USB storage type channel to poll if the other end of the present invention is connected to a PC. On the other hand, as in step 410, the two controllers of the migration cable will return the value 0 when the other end is not connected or has not issued to access the autorun image file; otherwise, value 1 is returned. This step is for testing if the local PC is connected.

After the Longhorn PC confirms that the other end of the migration cable is connected to a PC and performs the bus enumeration, and the local PC issues an ATAPI command to read the autorun image file, the Longhorn PC uses the subroutine SendAtutorunImage( ) to output the binary file stored in the hard disk, such as image or data file, through the bulk out pipe to the other PC in response to the ATAPI command, as in step 420. A part of the data of the autorun image file can be stored in the non-volatile flash memory of the migration cable, or preferably, in the embedded flash memory of the USB controller in the migration cable. For example, the USB can reply that itself is a CD player of the mass storage type, and the table of content (TOC) data inquired by the host is stored in the USB controller in the migration cable to accelerate the response time of the migration cable. The TOC data includes the type of CD, the starting address of the tracks, and so on.

The Longhorn PC will determine if the PC at the other end is also using the Longhorn operation system based on the value returned by DoorClose( ). This is because only the PC using next generation operation system or corresponding application has the specified autorun image file to reply the status to the routine DoorClose( ) as 1 to indicate that a CD is inside the player for accessing by the PC at the other end.

If both ends are using Longhorn operation system, the SourceSystem( ) subroutine will allow the user to select either one as a source or destination PC, or which part of the environment for migration, as in step 430, or using a default migration direction based on the version of the operation system or installation date. The GetMigration Data( ) is for getting the environment data from the other end, as in step 440. The Send Migration data(0 allows the Longhorn PC to send the environment, called migration data, as shown in step 450. The process terminates with the final step 460. When the main program of the Longhorn PC uses the DoorClose( ) to determine the PC at the other end is using older operation system, it can directly get the operation environment.

The aforementioned description is meant for explanation and should not be used as a limitation to the present invention. For example, the DoorClose( ) and Send AutorunImage( ) can be varied as checking the version of the operation system or application program, and allowing the newer autorun image file to update the older version image file. All these variations should all considered within the scope of the present invention.

In response to the main program in the Longhorn operation system for the migration cable of the present invention, the following is an embodiment of the firmware in the migration cable of the present invention. Again, it should be considered as an explanation instead of as a limitation.

| | |
|---|---|
| int DoorClsA,DoorClsB; | // Reset to 0 when bus reset or hardware reset occurs |
| int EnumA,EnumB; | // Reset to 0 when bus reset or hardware reset occurs |
| | // Set to 1 when enumeration completes |
| int ReadCmdA,ReadCmdB; | // Reset to 0 when bus reset or hardware reset occurs |
| | // Set to 1 when reading a CD-ROM image |
| int ConnectionA(void) | //respond SCSI connection( ) issued by Longhorn |
| { | |
| if(DoorClsA==0) | |
| DoorClsB = 1; | |
| if (EnumB == 0) return 0; | //check if the other end finishes enumeration |
| if (ReadCmdB == 0) return 0; | //check if the other end issues ATAPI |
| else return 1; | |
| } | |
| int ConnectionB(void) | //respond SCSI connection( ) issued by Longhorn |
| { | |
| if(DoorClsB==0) | |
| DoorClsA = 1; | |
| if (EnumA == 0) return 0; | // check if the other end finishes enumeration |
| if (ReadCmdA == 0) return 0; | // check if the other end issues ATAPI |
| else return 1; | |
| } | |
| int DoorCloseA(void) | // respond SCSI_DoorClose( ) issued by Longhorn |
| { | |
| return DoorClsA; | |
| } | |
| int DoorCloseB(void) | // respond SCSI_DoorClose( ) issued by Longhorn |
| { | |
| return DoorClsB; | |
| } | |

The above description explains the SCSI command issued by the Longhorn PC is responded by firmware. For example, the SCSI_Connection( ) issued by Longhorn PC is preferably responded by the firmware after checking if the bus enumeration and the ATAPI command are finished. If so, the confirmation response allows the Longhorn PC to exit the polling loop and send the autorun image file.

The following is an embodiment of the autorun image file. Again, it should be considered as an explanation instead of as a limitation.

AutorunImage

| | |
|---|---|
| main( ) | |
| { | |
| if (OSVersion( ) == LONGHORN) | // Only executed on XP/2000/ME |
| exit(0); | |
| else SendMigrationData( ); | // Send migration data to the other |
| | side |
| } | |

In summary, the aforementioned disclosures include a method for operation environment migration, including the following steps: determining if the vendor ID and product ID of a USB device is recognizable, declaring the first function of the USB device is a compact disk ROM, declaring the second function of the USB device is a USB migration device, automatically installing and executing the drivers and applications at the remote PC to the local PC based on the first function, analyzing the operation environment at the local PC, and migrating the operation environment at the local PC to the remote PC based on the second function. The operation environment includes a plurality of installed applications, the address book of the e-mail program, the favorite list of the Internet browser and a plurality of e-mails at the local PC.

The present invention also discloses a method for operation environment migration, including the following steps: the first PC inquires regularly to the USB migration device if a second PC is connected, automatically installing and executing the programs installed at the first PC to the second PC, such as applications and drivers, and sending the computing environment at the first PC to the second PC or the first PC obtaining the computing environment of the second PC.

The present invention further discloses a USB migration device, including a first USB connector, a second USB connector, a first USB controller coupled to the first USB connector, having an embedded first flash memory storing a non-volatile first firmware for operating the first USB controller, and a second USB controller coupled to the first USB controller, having an embedded second flash memory storing a non-volatile second firmware for operating the second USB controller, where the USB migration device uses the first USB controller to couple a first PC and the second USB controller to couple a second PC so that the second PC can automatically execute the drivers and the applications installed in the first PC to operate the USB migration device according to the autorun image file. Preferably, the first firmware and the second firmware are identical. When the applications are successfully installed at the second PC, the applications can analyze the operation environment at the second PC. During the initialization stage of the USB migration device, the USB migration device can report that the second PC is a USB compact disk ROM with a large storage. Preferably, the embedded second flash memory has a table of content (TOC) information, including the type and the starting address of the first track of the compact disk, so that the USB migration device can directly report the TOC information in the second flash memory to the second PC.

The present invention also discloses a system for operation environment migration, including a first PC, a second PC, and a USB migration cable having a first USB connector and a second USB connector. The USB migration cable includes a first USB connector, a second USB connector, a first USB controller coupled to the first USB connector, having an embedded first flash memory storing a non-volatile first firmware for operating the first USB controller, and a second USB controller coupled to the first USB controller, having an embedded second flash memory storing a non-volatile second firmware for operating the second USB controller, where the USB migration device uses the first USB controller to couple a first PC and the second USB controller to couple a second PC so that the second PC can automatically execute the drivers and the applications installed in the first PC to operate the USB migration device according to the autorun image file. The first PC can obtain the operation environment of the second PC through the USB migration device. Preferably, the operation environment includes the application installed, address book of the e-mail program, and the favorite list of the Internet browser.

The present invention further discloses a storage medium for computer access. The storage medium stores a computer executable program. The storage medium include an inquiry device which inquires, at a regular interval, the USB migration cable if a remote PC is connected, a transmission device for transmitting data through the USB migration cable to the remote PC for its installation of drivers and applications when the remote PC is confirmed by the inquiry device to be connected to the USB migration cable, a migration device for either obtaining an operation environment from a remote PC or sending an operation environment to the remote PC, and a detection device for detecting the version of the operation system at the remote PC. The applications can analyze the operation environment of the remote PC and obtain the operation environment through the USB migration cable.

The present invention further discloses a method for operation environment migration, including: determining if the vendor ID and product ID of the USB device are recognizable, declaring the USB device having the function of a compact disk ROM, based on the function, automatically installing and executing the drivers and the applications stored at the remote PC to the local PC, analyzing the operation environment of the local PC, and using the specific SCSI command to migrate the operation environment at the local PC to the remote PC.

While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

1. A method of operation environment migration for computers, comprising the steps of:
determining if a vendor ID and a product ID of a USB device being recognizable;
declaring a first function of said USB device being a CD player;
declaring a second function of said USB device is a USB migration device;
automatically installing and executing a driver and an application at a remote PC to a local PC based on said first function;
analyzing an operation environment at said local PC; and
migrating said operation environment at said local PC to said remote PC based on said second function.

2. The method as claimed in claim 1, wherein said operation environment comprises a plurality of installed application programs at said local PC.

3. The method as claimed in claim 1, wherein said operation environment comprises an address book of an e-mail program.

4. The method as claimed in claim 1, wherein said operation environment comprises a plurality of e-mail messages stored at said local PC.

5. The method as claimed in claim 1, wherein said operation environment comprises a my-favorite data stored at a web browser at said local PC.

6. A method of operation environment migration for computers, comprising the steps of:
a first PC periodically inquiring a USB migration device if connecting to a second PC; and
automatically installing and executing an application program stored in said first PC to said second PC.

7. The method as claimed in claim 6, wherein said step of automatically installing and executing further comprises automatically installing and executing a driver in said first PC to said second PC.

8. The method as claimed in claim 7 further comprising a step of sending an operation environment at said first PC to said second PC.

9. The method as claimed in claim 7 further comprising a step of getting an operation environment from said second PC by said first PC.

10. A USB migration cable, comprising:
a first USB connector;
a first cable having a first end and a second end, said first end connecting to said first USB connector;
a second USB connector;
a second cable having a first end and a second end, said first end connecting to said second USB connector; and
a USB migration device, said migration device further comprising:
a first USB controller coupled to said second end of said first cable, having an embedded first flash memory storing a non-volatile first firmware for operating said first USB controller; and
a second USB controller coupled to said first USB controller and said second end of said second cable having an embedded second flash memory storing a non-volatile second firmware for operating said second USB controller,
where said USB migration device uses said first USB controller to couple a first PC and said second USB controller to couple a second PC so that said second PC can automatically execute a driver and an application program installed on said first PC to operate said USB migration device according to an autorun image file.

11. The USB migration cable as claimed in claim 10, wherein contents of said first firmware and contents of said second firmware are practically identical.

12. The USB migration cable as claimed in claim 10, wherein said application program can analyze an operation environment of said second PC.

13. The USB migration cable as claimed in claim 10, wherein said USB migration device can report that said second PC is a CD player of a USB mass storage type.

14. The USB migration cable as claimed in claim 12, wherein said operation environment further comprises an address book of an e-mail program.

15. The USB migration cable as claimed in claim 13, said second flash memory stores a table of content data.

16. A system of operation environment migration for computers, comprising:
a first PC;
a second PC; and
a USB migration cable having a first USB connector and a second USB connector, said USB migration cable further comprising:
a first USB controller coupled to said first USB connector, having an embedded first flash memory storing a non-volatile first firmware for operating said first USB controller, and
a second USB controller coupled to said first USB controller and said second connector, having an embedded second flash memory storing a non-volatile second firmware for operating said second USB controller;
wherein said USB migration device uses said first USB controller to couple said first PC and said second USB controller to couple said second PC so that said second PC can automatically execute a driver and an application program installed on said first PC to operate said USB migration device according to an autorun image file to obtain an operation environment of said second PC through said USB migration device.

17. The system as claimed in claim 16, wherein said operation environment further comprises a plurality of installed application programs, an address book of an e-mail program, and my-favorite data of a web browser.

18. The system as claimed in claim 16, wherein said second PC inquires said USB migration cable on a table of content data.

19. The system as claimed in claim 18, wherein said table of content data further comprises a type of a CD and starting address of tracks.

20. The system as claimed in claim 19, wherein said table of content data is stored in said embedded flash memories.

21. A storage medium accessible to computers, storing a program executable by said computers, said storage medium comprising:
an inquiry device inquiring at a regular interval a USB migration cable if connecting to a remote PC; and
a transmission device for transmitting data through said USB migration cable to said remote PC for installing a driver and an application program when connecting said remote PC, according to an autorun image file to transmit data to said computer through said USB migration cable to install a driver and an application program on said computer.

22. The storage medium as claimed in claim 21, wherein said application program analyzes an operation environment of said computer and obtain said operation environment of said computer through said USB migration cable.

23. The storage medium as claimed in claim 21 further comprising a migration device for either obtaining an operation environment from said computer or sending an operation environment to said computer.

24. The storage medium as claimed in claim 21 further comprising a detection device for detecting a version of an operation system at said computer.

25. The storage medium as claimed in claim 22, wherein said operation environment comprises a plurality of installed application programs, an address book of a e-mail program, and my-favorite data of a web browser.

26. A method of operation environment migration for computers, comprising the steps of:
determining if a vendor ID and a product ID of a USB device being recognizable;
declaring said USB device having a function of a compact disk ROM;
automatically installing and executing a driver and an application program stored at a remote PC to a local PC based on said function;
analyzing an operation environment of said local PC, and
using a special SCSI command to migrate said operation environment at said local PC to said remote PC through a pipe of said function.

27. The method as claimed in claim 26, wherein said operation environment further comprises a plurality of installed application programs.

28. The method as claimed in claim 26, wherein said special command is a specially designed SCSI command.

29. The method as claimed in claim 26, wherein said operation environment further comprises an address book of an e-mail program.

30. The method as claimed in claim 26, wherein said operation environment further comprises a plurality of e-mail messages on said computer.

31. The method as claimed in claim 26, wherein said operation environment further comprises my-favorite data of a web browser.
